(19) United States
(12) Patent Application Publication
(10) Pub. No.: US 2015/0190757 A1
(43) Pub. Date: Jul. 9, 2015

(54) Capillary Filtration Membrane With An Improved Recovery And Method For Obtaining An Improved Recovery And Manufacturing Method

(71) Applicant: MICRONEXT B.V., Zutphen (NL)

(72) Inventors: Cornelis Johannes Maria van Rijn, Hengelo (NL); Paulus Hendricus Johannes Nederkoorn, Enschede (NL)

(73) Assignee: MICRONEXT B.V., Zutphen (NL)

(21) Appl. No.: 14/414,870

(22) PCT Filed: Jul. 15, 2013
(86) PCT No.: PCT/NL2013/050536

§ 371 Date: Jan. 14, 2015

(30) Foreign Application Priority Data
Jul. 17, 2012 (NL) 1039736

(51) Int. Cl. B01D 69/08; B01D 67/00; C02F 1/44; C12H 1/16; B01D 71/68; B01D 65/02

(52) U.S. Cl. CPC B01D 69/082; B01D 71/68; B01D 65/02; C02F 1/44; C12H 1/16; B01D 67/0009

(57) ABSTRACT

A filtration module is disclosed, comprising at least one hollow capillary filtration membrane, in particular having a retentate side inside the hollow capillary and a permeate side outside the capillary, characterized in that the retentate side of the capillary filtration membrane has at least one dent with an aperture angle Φ smaller than 180°.

A method to apply a filtration module according to the invention is disclosed characterized in that release of a cake layer formed at the retention side of the membrane is enforced, as well as further disrupture and disintegration of the cake layer, by applying a backwash cycle with a reverse flow at a backwash pressure lower than the maximum trans membrane pressure during a forward filtration step of a process liquid.

This application is the US national application of PCT/NL2013/050536, filed on Jul. 15, 2013 and which claims priority to Provisional Application No., NL 1039736 filed on Jul. 17, 2012, now expired, the disclosure of which is herein incorporated by reference in its entirety.

The invention relates to the filtration of fluids with a hollow capillary filtration membrane, in particular having a retentate side inside the hollow capillary and a permeate side outside the capillary.

To restore the original performance (or recovery) of the filtration membrane many kind of cleaning and backwash methods are available, generally specifically developed for a certain filtration process using a filtration module, having a large number of parallel placed capillary fibers.

Capillary membrane filters are an indispensable necessity in—for example but not limited to—the field of ultra/nano filtration of water and the microfiltration of beer and wine. For both applications poly ether sulphone based membrane fiber modules are regularly being used worldwide. However both applications are hampered by frequent backwash and cleaning process steps that may hamper the filtration efficiency. These backwash and cleaning steps are needed to remove the cake layer of the membrane surface. The cake layer is normally formed by all particles present in the fluid (to be filtered) that were not able to pass the pores of the membrane and foul the surface of the membrane.

Generally spoken, fouling can be divided into a reversible and an irreversible fouling contribution. Reversible fouling can be removed readily under the influence of hydrodynamic forces exerted during a backwash or a cross-flow operation under flow reversal conditions. Irreversible fouling is the contribution of fouling that cannot be removed during backwashing, and leads to a less than 100% recovery of the membrane after each backwash. Chemical cleaning is then the only option left to get a (nearly) 100% recovery. For ultra/nano filtration (virus removal) of potable water and microfiltration of beer and wine this is highly unwanted, because long lasting flushing steps of the micro porous membranes with dead-end cavities are needed to dilute the chemical cleaning agents to an acceptable food approved level before further processing. If after each backwash step the recovery drops with 1% than after 50 backwash steps the operating membrane flux has become significantly less than 50% and a chemical cleaning step is needed to get a full recovery.

Here we describe the development of an innovative sustainable product-process step that overcomes the limitations in the current applications. The construction and use of the novel means will be accurately described. Reducing reversible and irreversible accumulation of retained substances on the membrane surface leads to an overall decrease in operating costs.

It is an object of the present invention to develop microfiltration capillary membranes for—for example but not limited to—beer and wine clarification and/or sterile filtration, and to apply a process protocol to improve the recovery of each backwash step.

It is a further object of the present invention to develop ultra and nano capillary filtration membranes for potable water applications and to apply a process protocol to improve the recovery of each backwash step. Obviously other application for water treatment such as surface or waste water filtration may also benefit from the underlying invention. This filtration method could of course also be deployed in all sorts of liquid treatment applications where ultra, nano, or micro filtration is wanted.

It is an insight of the invention that reversible and irreversible fouling processes depend not only on the fluids to be filtered but also on the properties of the membrane filter, such as pore size, surface charge, and hydrophobicity. Sources for potable water can contain a large number of different components; it is found that irreversible fouling of a membrane by natural organic matter (NOM) is impaired by increasing the NOM molecular weight, decreasing the pH and increasing the electrolyte concentration. With respect to the membrane properties, it is found that irreversible fouling is enhanced if the membrane surface is relatively rough, hydrophobic or if the pore size is approximately equal to the particle size.

According to the invention the capillary filtration membranes are of the type which are made with a phase inversion process. Phase inversion is defined as the process in which a given extrusion solution containing a dissolved solid material is precipitated into at least two phases: a solid material-rich phase that forms the body material of the product and a material-poor phase that forms the pores inside the body material by bringing the extrusion solution into contact with a non-solvent. A non-solvent is defined as a medium in which the solid material (dissolved in the extrusion solution) will not dissolve.

With preference the capillary membranes are made with an extrusion process using a spinneret and a phase inversion technique using polyethersulphone (PES) and polyvinylpyrrolidone (PVP) as the solid material in the extrusion solution (or dope). The PVP is an additive and tends to reduce the solubility of the polymer in the dope solution herewith increasing the viscosity, which will favor the formation of the capillary membrane according to the invention.

During phase inversion polymer rich (for example PES) and polymer lean (for example PVP) phases are formed enforcing a large increase of viscosity in the polymer rich phase until solidification occurs, which is considered to be the end of the micro-structure formation process according to the invention. To get membranes with a very uniform structure without the formation of macro-voids (open spaces much larger than the pores) it is desirable to include water in the dope solution. During extrusion of the fiber when phase inversion takes place at the tip of the spinneret only solvent and non-solvent will diffuse rapidly through the polymer segments, which typically occurs in a fraction of a second. At this time scale the inter-diffusion of the hydrophobic (for example PES) and hydrophilic polymers (for example PVP) is negligible. The addition of water is intended to take the dope solution very near to the “cloud point” or precipitation point. This composition is very close to a point where any more addition of water, even in very small quantities, will create an unstable condition and precipitation will result. Therefore immediately after the fiber comes in contact with a bore fluid (typically a water/NMP mixture) and before it enters into a subsequent water bath, the cloud point will be reached instantaneously. This results in formation of an ultrathin skin. If the composition is not close or near the cloud point the thin layer will be formed over a period of time leading to varying thicknesses, during the further solidification in the water bath. During such a process an unwanted secondary skin can be formed and this should be avoided.

It is an object of the invention to form a highly porous skin membrane with an uniform porous support structure without macro voids. The suppression or absence of macro voids ensures an uniform, interconnected polymer network behind the thin skin and ensures a good mechanical strength of the fibers with respect to stretch ability, tensile strength and burst strength. All these parameters are important for fiber membranes according to the invention.

In ultra and nano filtration the removal of fouling agents during backwashing can be augmented by a pre-treatment, for example using a coagulant, as is done for example in potable water applications.

For sterile microfiltration of beer with for example said poly ether sulphone membranes reversible and irreversible fouling is observed, that leads to severe cake layer formation below a trans membrane pressure (TMP) of 0.50 bar, an increase in partial pore blocking at a TMP (typically) above 1.0 bar, and severe internal pore blocking (typically) at a TMP above 2.0 bar. Also conformal deposition of polyfenols from beer yields to a considerable irreversible flux decline during the filtration process. Easy and sustainable cleaning methods do not yet exist for all these applications.

It is a paramount insight of the invention that the cake layer (build up during inside/out filtration) forms a round shell, and consist of all particles that were not able to pass the pores of the membrane during a filtration step. This round shell continuously grows and becomes denser during the filtration step, especially if the TMP is gradually raised in order to maintain a minimum flux.

It is another main object to develop a membrane filtration process not only enabling an easy recovery of the filtration membrane but also to enhance the throughput for a given filtration system to minimize the ecological footprint of the process.

The invention in a preferred embodiment is related to a filtration module, having at least one hollow capillary filtration membrane, having a retentate side, in particular inside the hollow capillary, and a permeate side, in particular outside the capillary, characterized in that the retentate side of the capillary filtration membrane has at least one dent with an aperture angle Φ smaller than 180°. The dent has a top with a radius of curvature smaller than 250 micrometer. Thus the top of the dent is relative “sharp” pointed.

With this concave inner shape according to the invention the cake layer (normally formed as a round shell) has now a weak point near the relative “sharp” pointed top of the dent, herewith enabling a faster breakup and dissolution during the recovery step in the filtration process when a backwash or a permeate flow reversal step is executed. Near the tip of the dent a small reverse flow will create a sufficient pressure to induce at that point a break through of the cake layer. Due to the dent in the cake layer the pressure induced will firstly release the cake layer from the corresponding dent in the membrane surface, and a break through in the cake layer is easily enforced. As soon as the break through is realized in the cake layer a subsequent induced transverse liquid flow at the flank of the cake layer will secondly disrupt and disintegrate the cake layer.

It is a paramount insight of the invention that a normally fully round or convex shaped cake layer shell is quite resistant against an applied pressure, similar as a dome shaped shell of an egg can withstand large exerted forces. A form comprising concavity(having points of inflection) for example a form comprising a triangular shaped dent will restrict this strength to a great extent.

With preference the dent should be as sharp as possible, in particular with a global aperture angle Φ typically smaller than 150°, and in some cases smaller than 120° with a radius of curvature at the top of the dent less than 100 micrometer. Both the release of the cake layer from the corresponding dent in the membrane surface is more easily enforced, as well as the further rupture and disintegration the cake layer during backwashing.

In particular the module comprises at least two dents, with indents being defined in between each pair of adjacent dents.

With preference the number of dents according to the invention is an integer between 5 and 13. Capillary membranes with an impair number of dents were surprisingly found more tough, while maintaining a good recovery. Tough means here their resistance to compressibility when such a fiber was squeezed between two plates. The resistance to compressibility was upto 15% higher for fibers having an uneven number of dents. This may be attributed to the configuration of the dents; for an impair number the opposing (180°) of a concave indent is a convex dent, herewith more balancing the stress forces during compressibility from the outside to the inside of the fiber during back wash strokes. Fibers with less or equal than 13 dents show a significant better recovery, possibly due to the better defined shape of the dents with a small radius of curvature. Also during assembly of the module a higher packing density of fibers (upto 15%) could be obtained without mechanical distortion on squeezing the fibers towards each other when potting the fibers.

With preference the shape of the dents according to the invention is triangular and with preference the tip of the dent should be as sharp as possible, with an aperture angle Φ typically smaller than 150°, and the radius of curvature at the vertex being not more than 250 micrometers and preferably less than 100 micrometer. The shape of the membrane area between the dents/teeth, that is to say the abovementioned indents, is with preference not sharp to prevent the built up of stress forces that might weaken the capillary when an external filtration or backwash pressure is applied. For those indents lying in between the dents/teeth an aperture angle Φ is typically larger than 240°, and also a radius of curvature at the vertex larger than 100 micrometers and preferably larger than 250 micrometer is chosen.

It will be clear that the invention is not restricted to inside/out membrane capillary filtration membranes, but can easily be extended by the man skilled in the art to outside/in capillary and also flat sheet corrugated membrane applications.

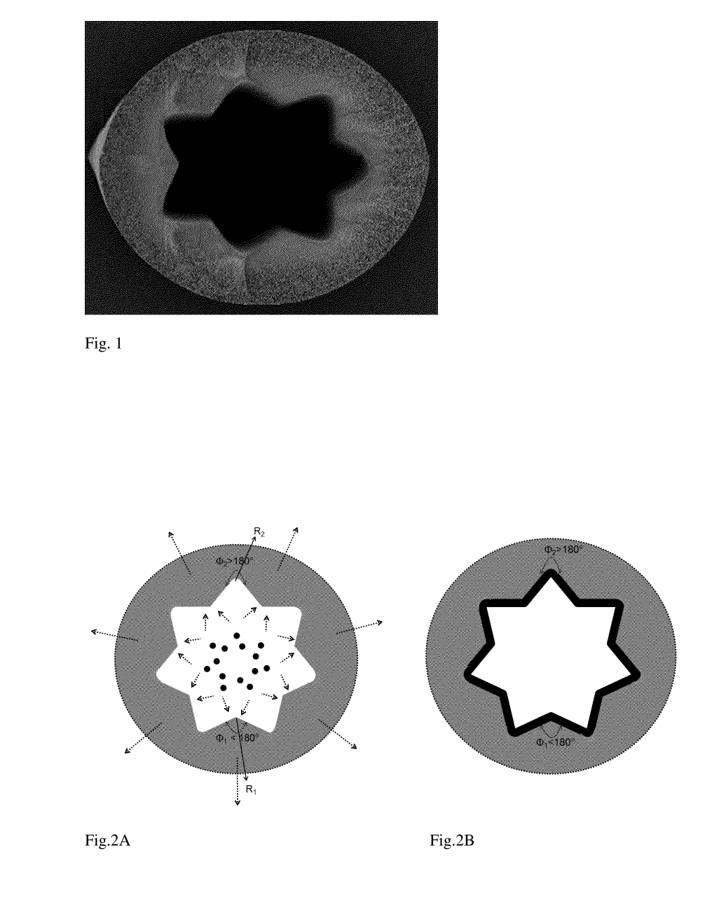

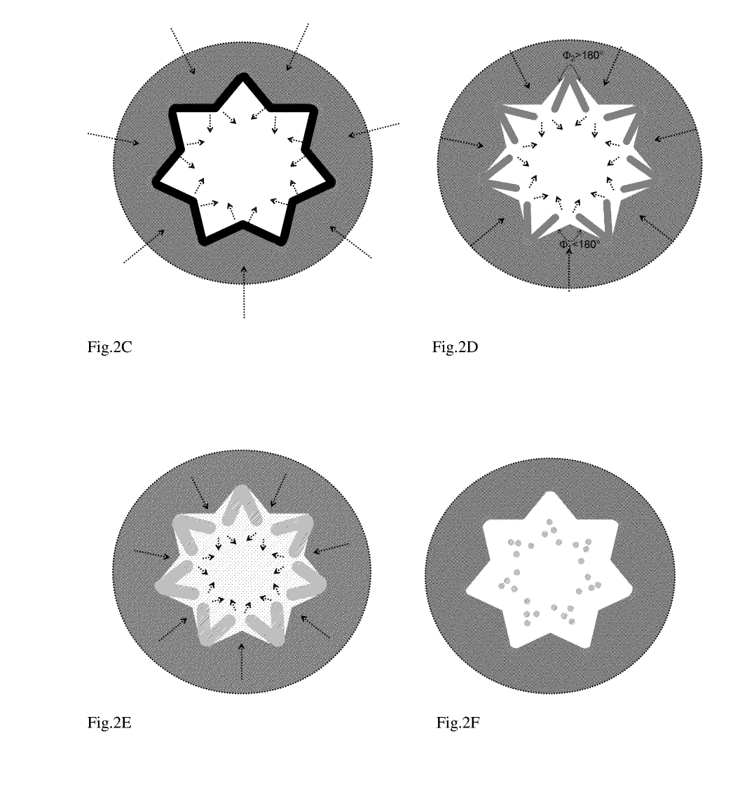

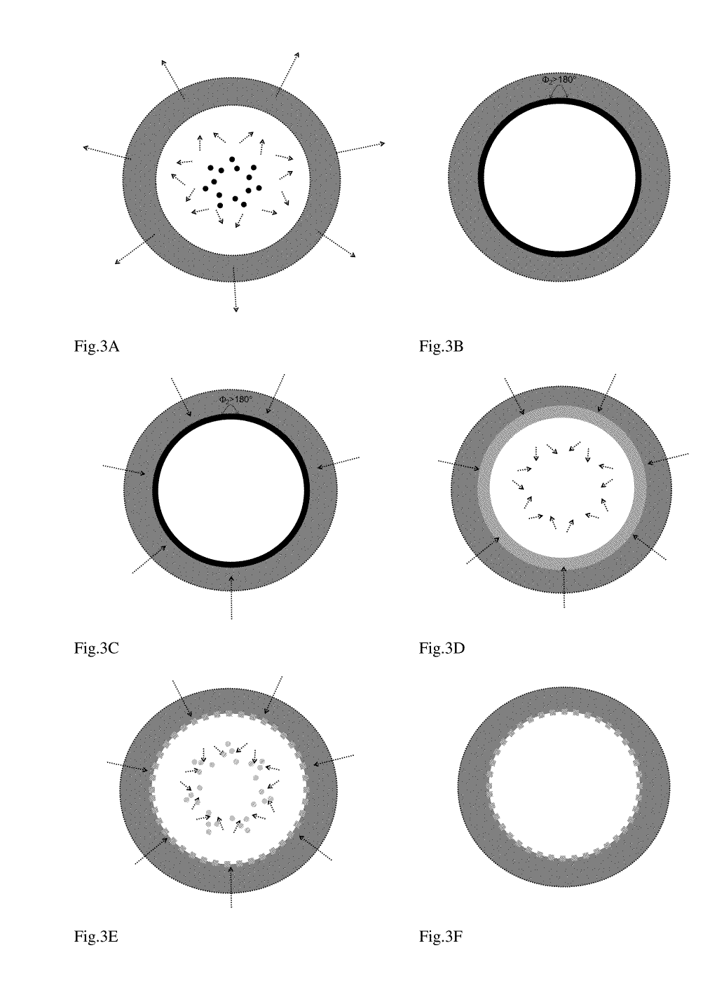

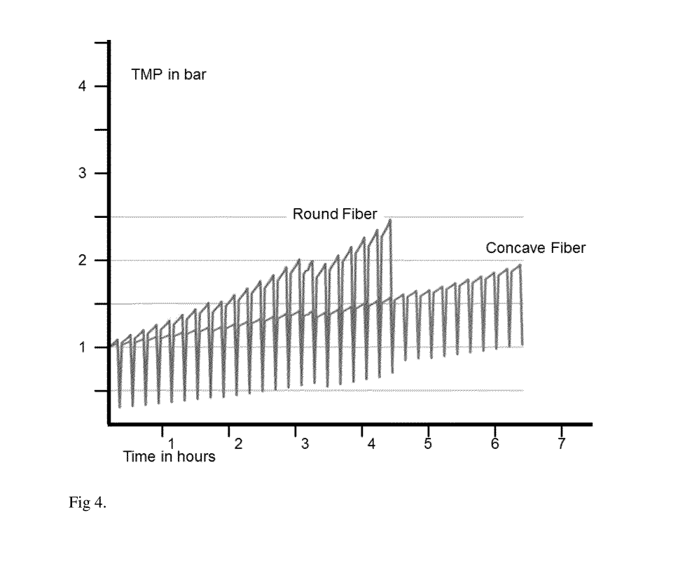

The invention will now be further exemplified with FIG. 1, showing a polyether sulphone membrane with 7 dents, FIG. 2A-F, describing the subsequent process steps needed to get a good membrane recovery in a micro-structured (formed with convex dents altered with concave indents) capillary membrane with 7 (convex) dents and 7 (concave) indents and FIG. 3A-F, describing the subsequent steps needed to get a normal membrane recovery in a round capillary membrane. In FIG. 4 a typical TMP-time graph has been depicted for a normal membrane and one according to the invention with a micro structured capillary membrane.

### EXAMPLE 1

### Extrusion of Micro-Structured Capillary Membrane with Phase Inversion

A micro structured capillary membrane with 7 dents has been extruded using a phase inversion technique with a very viscous dope solution comprising PES, a first PVP with a molecular weight between 50.000 and 2.000.000, a second PVP with a molecular weight between 10.000 and 100.000 and a sufficient amount of water to bring the solution close to the cloud point. FIG. 1 shows a cross section of the capillary membrane with an outer diameter of 1.4 millimeter. The shape of the dents are triangular and the tip of the dents are sharper than the vertex area between the dents. The aperture angle Φ₁ of the dents is here about 120°, and a radius of curvature R₁ at the vertex much less than 250 micrometers. The shape of the indents/membrane area between the dents/teeth is much less sharp to prevent the built up of stress forces that might weaken the capillary when an external filtration or backwash pressure is applied. Between the dents/teeth the aperture angle Φ₂ of the indents is here 270°, and a radius of curvature R₂ at the vertex is much larger than 100 micrometers.

### EXAMPLE 2

### Comparing Capillary Membranes with a Round and with a Micro-Structured Inner Shape According to the Invention

FIG. 2A depicts a micro-structured capillary membrane with 7 dents having an aperture angle Φ₁<180°. Inverted dents, here referred to as the indents (area between two protruding polymeric dents) with an aperture angle Φ₂>180° are also depicted. The flow of liquid is from the inside to the outside of the microporous capillary during a normal filtration step as indicated by the arrows. After a period of filtration all the retained particles will form a thick and dense cake layer on the micro-structured inner part of the capillary membrane (FIG. 2B). In FIG. 2C a backwash step is depicted indicated by a reversal of the flow from the outside to the inside of the capillary. In FIG. 2D it is depicted that at the points with an aperture angle Φ₁<180° a sufficient pressure is exerted to enforce a break through of the cake layer and that the pressure induced will further release the cake layer from the dent. As soon as the break through is realized in the cake layer a subsequent induced transverse liquid flow at the flank of the cake layer will disrupt and disintegrate the cake layer (FIGS. 2E and 2F).

FIG. 3A-F, describe the subsequent steps needed to get a normal membrane recovery in a round capillary membrane. FIG. 3A depicts a normal round capillary membrane. The flow of liquid is from the inside to the outside of the microporous capillary during a normal filtration step as indicated by the arrows. After a period of filtration all the retained particles will form a thick and dense cake layer on the inner part of the capillary membrane (FIG. 3B). Also depicted here is that due to the capillary curvature an aperture angle Φ₂>180° can be defined.

In FIG. 3C a backwash step is depicted indicated by a reversal of the flow from the outside to the inside of the capillary exerted by a high pressure, however a break through of the cake layer is not enforced, because the perfect cylindrical (cf. a dome) shape redistributes the inward forces exerted on the cake layer. Instead after a while the cake layer swell, but is not easily released from the membrane surface (FIG. 3D). After a while the cake layer will become sufficiently porous for transport of more and more backwash liquid and the cake layer will start to disintegrate (FIG. 3E), leaving debris on the membrane surface causing an irreversible fouling layer (FIG. 3F), that only can be removed with a rigorous chemical cleaning step.

### EXAMPLE 3

### Recovery Behavior of Capillary Membranes with a Round and with a Micro-Structured (Alternation of Convex Dents and Concave Indents) Inner Shape

In FIG. 4 a typical TMP-time graph has been depicted for recovery cycles of a normal round capillary membrane (20 recovery cycles) module and one according to the invention with a micro-structured capillary membrane having 7 dents (33 recovery cycles).

Both membrane modules were selected in having a comparable membrane surface area (2.4 m²), a comparable pure water permeability and a similar cut-off (280 and 300 kD). Both modules were driven at a steady process flux of 40 l/m²/hour and the feed was (dirty) surface water from a nearby lake. The initial flow resistance should therefore be similar and the difference can only be caused by a difference in recovery behavior during the backwash cycles. The backwash flux was also set at 40 l/m²/hour for a few minutes and further filtration was pursued. Surprisingly it was found that the resistance of the module with the micro-structured capillaries barely increased after 33 backwash cycles, whereas the module with the conventional capillaries showed a severe increase already after 20 backwash cycles. The result was confirmed in two other experiments by interchanging the modules in the filtration set-up. Obtained permeate 25 samples have been checked with standard chromatography (HPLC) and were found to have a similar spectrum. In both cases, cleaning the membranes with a special purpose cleaning agent nearly completely restored the permeability. Surprisingly we (statistically significant) found that the recovery of the normal round capillary membrane module (<99%) was less than the recovery of the micro-structured capillary membrane module (>99.5%) after chemical cleaning. This may be caused by less attachment of (irreversible) fouling agents to the micro-structured membrane surface and an increased attachment of them to the conventional round membrane surface (cf. FIGS. 2F and 3F). The applied pressure to induce a back wash of the capillary membrane can normally be chosen higher than the highest trans membrane pressure during filtration to release the cake layer formed at the retention side of the membrane. According to the invention the disintegration of the cake layer by applying a backwash cycle with a reverse flow can now very well be obtained using a backwash pressure lower or comparable than a maximum trans membrane pressure during a forward filtration step of a process liquid with the filtration module comprising the micro-structured capillaries. Also in performed sterile beer filtration and wine clarification trials this recovery advantage after both backwashing and chemical cleaning steps was a significant improvement.

1. Filtration module, comprising at least one hollow capillary filtration membrane made with a phase inversion process, having a retentate side and a permeate side , characterized in that the retentate side of the capillary filtration membrane comprises at least one dent with an aperture angle Φ smaller than 180° and a radius of curvature smaller than 250 micrometer.

2. Filtration module according to claim 1, characterized in that the dent has a global aperture angle Φ typically smaller than 150°.

3. Filtration module according to claim 1, characterized in that the dent is as sharp as possible, with a global aperture angle Φ typically smaller than 120°, and/or a radius of curvature smaller than 100 micrometer.

4. Filtration module according to claim 1, characterized in that at least two dents are provided, in which the area between the two dents is less sharp, with a global aperture angle Φ larger than 180°, and a radius of curvature larger than 100 micrometer.

5. Filtration module according to claim 4, characterized in that the area between two dents is less sharp, with a global aperture angle Φ typically larger than 240°, and a radius of curvature larger than 250 micrometer.

6. Filtration module according to claim 1, characterized in that the shape of the dents is triangular.

7. Filtration module according to claim 1 characterized in that the number of dents is an impair number, preferably between 5 and 13.

8. Filtration module according to claim 7, characterized in that the number of dents is between 7 and 11.

9. Filtration module according to claim 1, characterized in that the retentate side is inside the hollow capillary and that the permeate side is outside the capillary.

10. Filtration module according to claim 1, characterized in that the retentate side is outside the hollow capillary and that the permeate side is outside the capillary.

11. Filtration module according to claim 1, characterized in that the capillary filtration membrane is made out of a polymer, and in particular comprises polyethersulphone (PES).

12. Filtration module according to claim 1, characterized in that the retentate side of the capillary filtration membrane comprises at least one indent, in particular one with a concave shape, which indent has an aperture angle Φ larger than 180°, and a radius of curvature larger than 100 micrometer.

13. Method to apply a filtration module according to claim 1, characterized in that release of a cake layer formed at the retentate side of the membrane is enforced, as well as further rupture and disintegration of the cake layer, by applying a backwash cycle with a reverse flow at a backwash pressure lower or comparable than the maximum trans membrane pressure during a forward filtration step of a process liquid.

14. Method according to claim 13, characterized in that the permeate of the process liquid is potable water.

15. Method according to claim 13, characterized in that the permeate of the process liquid is beer or wine.

16. Method for manufacturing a membrane filtration module according to claim 1, characterized in that the capillary filtration membrane with the at least one dent at the retentate side is made with a phase inversion process.
